(19) United States
(12) Patent Application Publication
(10) Pub. No.: US 2008/0270401 A1
(43) Pub. Date: Oct. 30, 2008

(54) Method and Apparatus for Displaying Sorted Test Data Entries

(76) Inventors: Kristin Petersen, Clifton Park, NY (US); Carli Connally, Fort Collins, CO (US)

Correspondence Address: Gregory W. Osterloth;Holland & Hart, LLP, P.O. Box 8749, Denver, CO, 80201, US

(21) Appl. No.: 11/740,694

(22) Filed: Apr. 26, 2007

(51) Int. Cl. G06F 7/00

(52) U.S. Cl. 707/7; 707/E17.033

(57) ABSTRACT

In one embodiment, a plurality of test data items are grouped to form a plurality of test data entries. The test data items include both test results and test result identifiers, and each of the test data entries includes at least one of the test results and one of the test result identifiers. The test data entries are sorted in accord with one or more of the test data items found within the test data entries, and a dynamically updated range of the sorted test data entries is displayed via a sorted table of a graphical user interface (GUI). At least one sort mechanism is provided via the GUI. The at least one sort mechanism enables a user to change the one or more test data items via which the test data entries are sorted. Other embodiments are also disclosed.

### BACKGROUND

When testing circuit devices such as system-on-a-chip (SOC) devices, test data is typically acquired, saved and displayed in bulk form. This makes it impossible to display the data in different ways without re-processing the entire data set.

### BRIEF DESCRIPTION OF THE DRAWINGS

Illustrative embodiments of the invention are illustrated in the drawings, in which:

FIG. 1 illustrates an exemplary method for displaying sorted test data entries; and

FIGS. 2 & 3 illustrate exemplary states of a GUI via which the method shown in FIG. 1 may be implemented.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

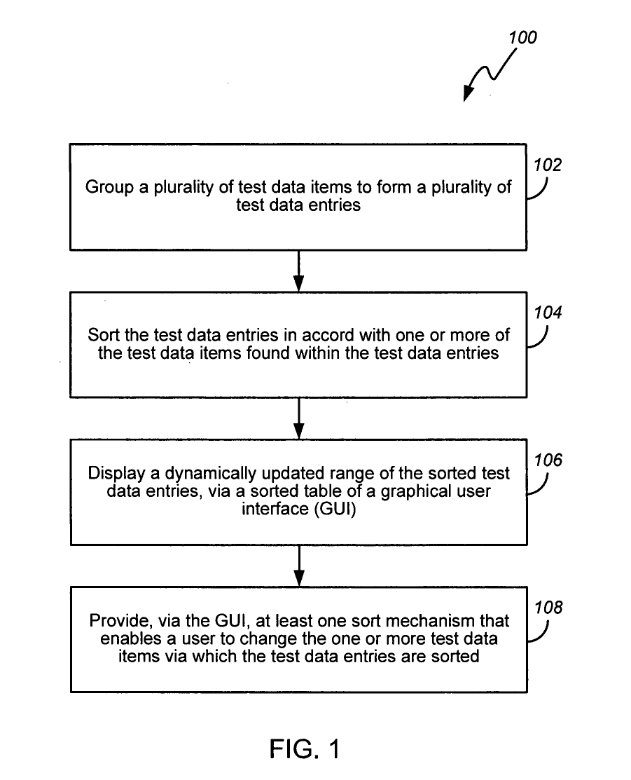

In accord with one embodiment of the invention, FIG. 1 illustrates a computer-implemented method 100. The method 100 begins with the grouping of a plurality of test data items to form a plurality of test data entries. The test data items include both test results and test result identifiers, and each of the test data entries includes at least one of the test results and one of the test result identifiers. See, block 102. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the United States patent application of Connally, et al. entitled “Apparatus for Storing and Formatting Data” (Ser. No. 11/345,040).

During or after (and preferably during) the formation of the test data entries (block 102), the test data entries are sorted in accord with one or more of the test data items found within the test data entries. See, block 104. A dynamically updated range of the sorted test data entries is then displayed via a sorted table of a graphical user interface (GUI). See, block 106. At least one sort mechanism is also provided via the GUI. See, block 108. The sort mechanism enables a user to change the one or more test data items via which the test data entries are sorted.

The method 100 is useful, in part, because it enables a user to display collections of test data (i.e., test data entries) in accord with different user-selected sort orders. Also, a new sort order may be initiated at any time. Thus, for example, a new sort order may be initiated, and the test data entries may be re-sorted, 1) while new ones of the test data entries are being formed, or 2) while the test data items on which the entries are based are still being generated by (or received from) a tester. In the past, collections of test data could not be re-sorted after a display process has begun, because test data was displayed in bulk form, and not as individual “entries” whose sort order could be changed.

Of note, the steps of the method 100 may take orders other than those shown in FIG. 1. However, it is preferred that the method's steps 102, 104, 106, 108 be performed repetitively, and substantially in parallel.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

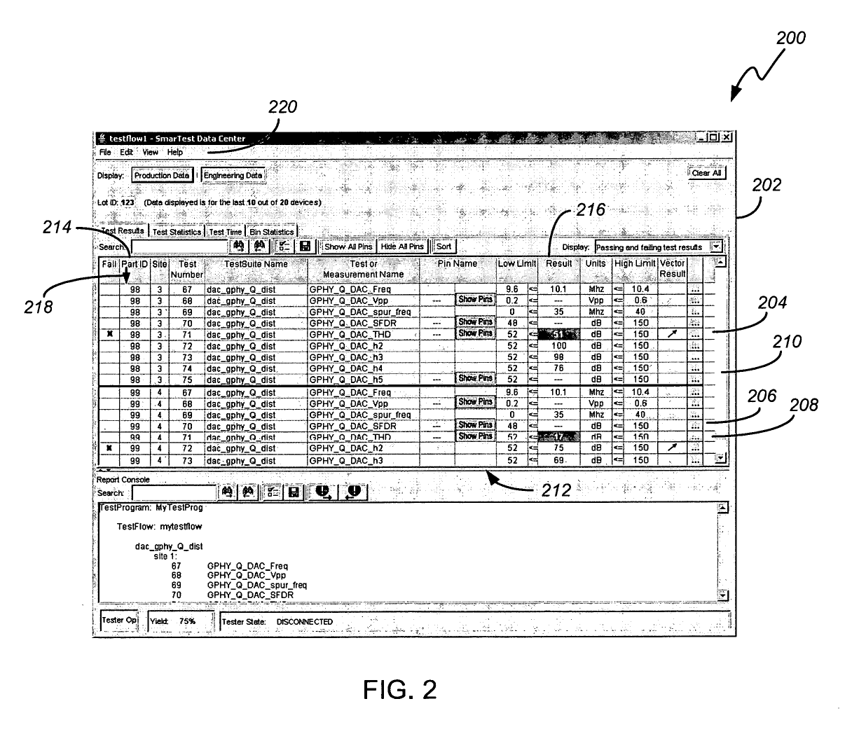

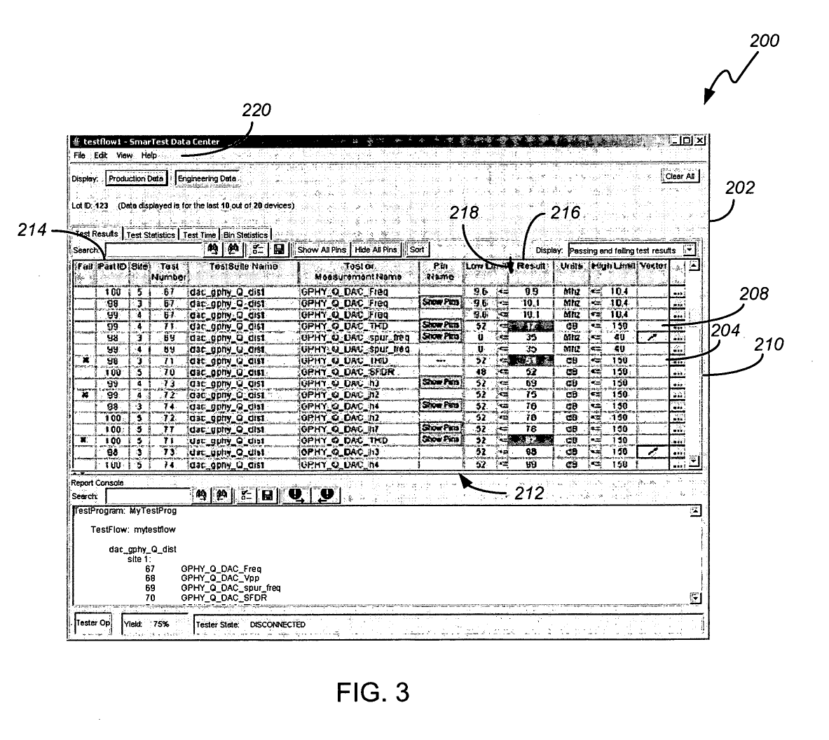

FIG. 2 illustrates an exemplary window (or screen) 202 of a GUI 200 via which the method 100 may be implemented. As shown, a plurality of test data entries 204, 206, 208 composed of various test data items (such as a “Test Number” and a “Result”) are displayed via the window 202. By way of example, each test data entry 204, 206, 208 comprises three test result identifiers, including: a “Test Number”, a “Test or Measurement Name”, and a “TestSuite Name” that identifies a test suite to which the test name and number belong. In addition, each test data entry 204, 206, 208 comprises: information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar 210 may be provided to allow a user to navigate to different test data entries or items.

As further shown in FIG. 2, each of the test data entries 204, 206, 208 is displayed as a line of a sorted table 212, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

Each of the columns in the table 212 includes a column header, such as the header 214 or the header 216. In one embodiment of the GUI 200, each of the column headers 214, 216 serves as a sort mechanism, and a user's graphical selection of (e.g., click on) one of the headers 214, 216 initiates a re-sort of the test data entries 204, 206, 208, in accord with the test data items referenced by the selected header. In FIG. 2, the test data entries 204, 206, 208 are shown to be primarily sorted by the test data items appearing under the “Part ID” header of the table 212. On a secondary basis, the test data entries 204, 206, 208 shown in FIG. 2 are also sorted chronologically. However, they could also be sorted based on other secondary bases, in accord with test data items appearing under other headers. In FIG. 3, the test data entries 204, 206, 208 are shown to be primarily sorted by the test data items appearing under the “Result” header of the table 212 (and then, chronologically).

Although FIGS. 2 & 3 show two possible sort orders for the test data entries 204, 206, 208 of the table 212, other sort orders are possible. For example, test data entries 204, 206, 208 could be sorted by any test data item that includes a test result, such as a pass/fail indication (e.g., those test data items that appear in the “Fail” field of table 212) or a test measurement (e.g., those test data items that appear in the “Result” field of table 212). The test data entries 204, 206, 208 could also be sorted by any test data item that includes a test result identifier, such as a test number (e.g., those test data items that appear in the “Test Number” field of table 212) or test name (e.g., those test data items that appear in the “Test or Measurement Name” field of table 212). Sort orders may also be based on other test data items that are capable of being parsed and sorted.

In the absence of user input via a sort mechanism (e.g., one of the headers 214, 216), the test data entries 204, 206, 208 may be sorted chronologically, or according to some other default sort order.

In FIGS. 2 & 3, the primary sort order for the test data entries 204, 206, 208 is indicated by an arrow 218 appearing in one of the table's headers 214, 216. The direction of the arrow 218 indicates whether the sort order is ascending or descending, and by clicking on an already selected header, the direction of the sort order can be changed.

Instead of, or in addition to, implementing a sort mechanism as a column header, a GUI 200 could provide other kinds of sort mechanisms. For example, a GUI 200 could implement a sort mechanism as a menu item that is obtained, for example, by 1) right-clicking on the table 212 to obtain a pop-up menu of test data items via which the test data entries 204, 206, 208 may be sorted, or by 2) launching a drop-down menu of test data items via which the test data entries 204, 206, 208 may be sorted (e.g., from a menu bar 220).

If a user highlights or otherwise selects a particular one of the test data entries 204, 206, 208, the table 212 may be “parked” about the particular test data entry. However, if a newly formed test data entry falls within a currently displayed range about the particular test data entry, the displayed range may be dynamically updated to include the newly formed test data entry. In the absence of a user selecting a particular one of the test data entries 204, 206, 208, the range of test data entries 204, 206, 208 displayed in the table 212 may be dynamically updated to include a most recently formed one (or ones) of the test data entries.

What is claimed is:

1. A computer-implemented method, comprising:
grouping a plurality of test data items to form a plurality of test data entries, wherein the test data items include test results and test result identifiers, and wherein each of the test data entries includes at least one of the test results and at least one of the test result identifiers;
sorting the test data entries in accord with one or more of the test data items found within the test data entries;
displaying a dynamically updated range of the sorted test data entries, via a sorted table of a graphical user interface (GUI); and
providing, via the GUI, at least one sort mechanism that enables a user to change the one or more test data items via which the test data entries are sorted.

2. The method of claim 1, further comprising:
updating a sort order of the test data entries as new ones of the test data entries are being formed; and
if a new one of the test data entries falls within the dynamically updated range of the sorted test data entries, displaying the new one of the test data entries via the sorted table.

3. The method of claim 1, wherein, in an absence of user input via the at least one sort mechanism, the range of the sorted test data entries is dynamically updated to include a most recently formed one of the test data entries.

4. The method of claim 1, wherein, in an absence of user input via the at least one sort mechanism, the test data entries are sorted chronologically.

5. The method of claim 1, wherein the at least one sort mechanism includes column headers for the sorted table.

6. The method of claim 1, wherein the at least one sort mechanism provides a means to sort the test data entries by test data items that include test results.

7. The method of claim 6, wherein the test result is a pass/fail indication.

8. The method of claim 6, wherein the test result is a test measurement.

9. The method of claim 1, wherein the at least one sort mechanism provides a means to sort the test data entries by test data items that include test numbers.

10. The method of claim 1, wherein the at least one sort mechanism provides a means to sort the test data entries by test data items that include test names.

11. The method of claim 1, further comprising:
in response to user input via the at least one sort mechanism, re-sorting the test data entries as new ones of the test data entries are being formed.

12. Apparatus, comprising:
computer-readable media;
computer-readable code, stored on the computer-readable media, including,
code to cause a computer to group a plurality of test data items to form a plurality of test data entries, wherein the test data items include test results and test result identifiers, and wherein each of the test data entries includes at least one of the test results and at least one of the test result identifiers;
code to cause the computer to sort the test data entries in accord with one or more of the test data items found within the test data entries;
code to cause the computer to display a dynamically updated range of the sorted test data entries, via a sorted table of a graphical user interface (GUI); and
code to cause the computer to provide, via the GUI, at least one sort mechanism that enables a user to change the one or more test data items via which the test data entries are sorted.

13. The apparatus of claim 12, further comprising:
code to cause the computer to update a sort order of the test data entries as new ones of the test data entries are being formed; and
code to, if a new one of the test data entries falls within the dynamically updated range of the sorted test data entries, cause the computer to display the new one of the test data entries via the sorted table.

14. The apparatus of claim 12, wherein, in an absence of user input via the at least one sort mechanism, the code dynamically updates the range of the sorted test data entries to include a most recently formed one of the test data entries.

15. The apparatus of claim 12, wherein, in an absence of user input via the at least one sort mechanism, the code chronologically sorts the test data entries.

16. The apparatus of claim 12, wherein the at least one sort mechanism includes column headers for the sorted table.

17. The apparatus of claim 12, wherein the at least one sort mechanism provides a means to sort the test data entries by test data items that include test results.

18. The apparatus of claim 17, wherein the test result is a pass/fail indication.

19. The apparatus of claim 17, wherein the test result is a test measurement.

20. The apparatus of claim 12, wherein the at least one sort mechanism provides a means to sort the test data entries by test data items that include test numbers.

21. The apparatus of claim 12, wherein the at least one sort mechanism provides a means to sort the test data entries by test data items that include test names.

22. The apparatus of claim 12, further comprising:
code to cause the computer to, in response to user input via the at least one sort mechanism, re-sort the test data entries as new ones of the test data entries are being formed.

23. The apparatus of claim 12, wherein the test data entries pertain to tests of a system-on-a-chip (SOC) device.
